(19) United States
(12) Patent Application Publication
(10) Pub. No.: US 2011/0157109 A1
(43) Pub. Date: Jun. 30, 2011

(54) HIGH-VOLTAGE CONSTANT-CURRENT LED DRIVER FOR OPTICAL PROCESSOR

(75) Inventor: MIROSLAV SVAJDA, SAN JOSE, CA (US)

(73) Assignee: SILICON LABORATORIES INC., AUSTIN, TX (US)

(21) Appl. No.: 12/650,738

(22) Filed: Dec. 31, 2009

(51) Int. Cl. G09G 5/00

(52) U.S. Cl. 345/205

(57) ABSTRACT

An LED driver comprises a first transistor for setting an output current level at an output of the LED driver that is responsive to a programmable current and an input signal. A second transistor in series with the first transistor provides voltage protection for the first transistor. The first transistor and the second transistor support an output voltage higher than a maximum operating voltage of either of the first or the second transistor alone. Biasing circuitry generates an adaptive bias voltage for the second transistor to protect the first transistor and the second transistor from high voltage levels at the output of the LED driver.

### CROSS-REFERENCE TO RELATED APPLICATIONS

N/A

### TECHNICAL FIELD

The present invention relates to LED drivers, and more particularly, to high voltage LED drivers.

### BACKGROUND

LED drivers are used for driving LED displays for various interfaces associated with electronic circuitries. The LEDs driven by the LED driver circuits have their brightness directly related to the current applied to the LED. The voltage developed across an LED depends primarily upon the semiconductor design and technology used and other manufacturing tolerances. When multiple LEDs are driven simultaneously or the optical processor operates at a low supply voltage, it is desirable to have the LED driver circuitry implemented using standard low voltage CMOS technologies with high-voltage compliance. However, existing designs can be susceptible to high voltages at the driver output. LED drivers can be embedded in an optical processor, which can be implemented in a submicron CMOS technology. Output of the LED driver requires a certain minimum bias (saturation voltage), which depends on the driver's output circuit design and current it drives. The LED supply has to be greater or equal to the LED driver's saturation voltage plus the voltage drop across the LED connected between the LED voltage supply and the driver's output. For examples, typical infrared LED forward voltage drop can be 1.5-2.5V within its operating current range. A standard low-voltage sub-micron CMOS technology may not support a voltage required to drive a single LED or a stack of multiple LEDs.

### SUMMARY

The present invention, as disclosed and described herein, in one aspect thereof, comprises on LED driver including a first transistor for setting an output current level at an output of the LED driver that is responsive to a programmable current and an input signal. A second transistor in series with the first transistor provides voltage protection for the first transistor. The first transistor and the second transistor support an output voltage higher than a maximum operating voltage of either of the first or the second transistor alone. Biasing circuitry generates an adaptive bias voltage for the second transistor to protect the first transistor and the second transistor from high voltage levels at the output of the LED driver.

### BRIEF DESCRIPTION OF THE DRAWINGS

For a more complete understanding, reference is now made to the following description taken in conjunction with the accompanying Drawings in which:

FIG. 1 illustrates an optical processor for driving multiple LEDs responsive to signals from a host processor and optical signals from LEDs;

FIG. 2 illustrates a first embodiment of an optical processor associated with an LED driven from a first voltage level;

FIG. 3 illustrates an optical processor associated with a pair of LEDs driven from a second voltage level;

FIG. 4 is a functional block diagram of an optical sensor that includes three LED drivers;

FIG. 5 is a simplified schematic diagram of the LED driver circuitry in FIG. 4;

FIG. 6 is a more detailed schematic diagram of the LED driver circuit of FIG. 5;

FIG. 7 is a schematic diagram of the ESD protection circuitry, cascode transistor rising circuitry and output current mirror scaling circuitry of the LED driver;

FIG. 8 is a schematic diagram of the reference current I_{REF} scaling circuitry of the LED driver;

FIG. 9 is a simplified schematic diagram illustrating the configuration of the LED driver circuitry when the LED driver is inactive;

FIG. 10 is a simplified schematic diagram illustrating the configuration of the LED driver circuitry when the LED driver is active;

FIG. 11 is a simplified schematic block diagram illustrating the LED driver circuitry operating as a GPIO output; and

FIG. 12 is a simplified schematic diagram illustrating the LED driver circuit operating as a GPIO input.

### DETAILED DESCRIPTION

Referring now to the drawings, wherein like reference numbers are used herein to designate like elements throughout, the various views and embodiments of a high-voltage constant-current LED driver for optical processors are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

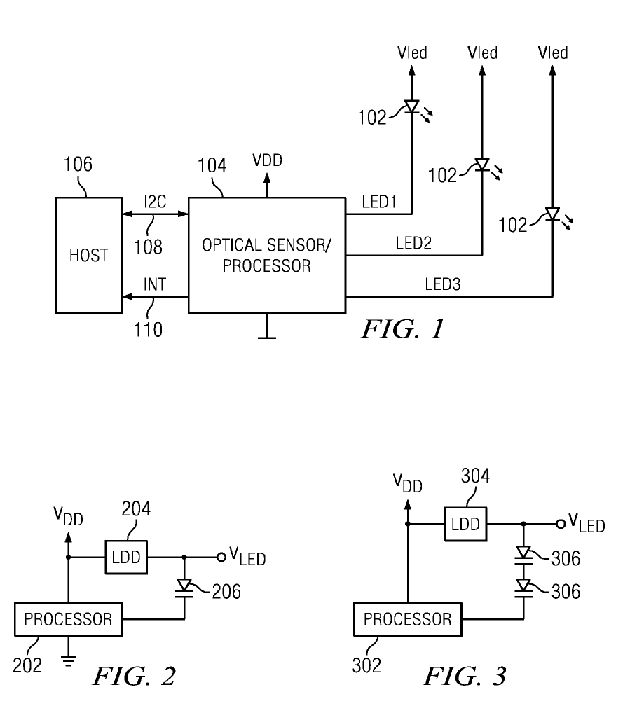

Referring now to the drawings, and more particularly to FIG. 1, there is illustrated a function block diagram of the circuitry for driving a plurality of LEDs 102. Each of the LEDs 102 is connected between the LED voltage (V_{LED}) node and an output pin of an optical processor 104. Each LED 102 has a separate LED pin associated therewith. The optical processor 104 receives controlling signals from a host processor 106 and optical signal from LEDs 102. In one embodiment, the communications interface between the host processor 106 and the optical processor 104 may comprise an I²C interface bus 108. The optical processor 104 may send back interrupt signals to the host processor 106 via an interrupt line 110.

Referring now to FIGS. 2 and 3, there are illustrated the various differing voltages which may be associated with the optical processor and LED circuitry. In FIG. 2, the LED 206 is connected to receive a system voltage V_{LED} of approximately 2-3.5 volts. In addition to be provided to the LED 206, the voltage V_{LED} is applied to an LDO voltage regulator 204. The LDO voltage regulator 204 provides the supply voltage to optical processor 202. LED 206 is also connected between V_{LED} and the driver circuitry which is integrated within the optical processor 202. When LED voltage V_{LED} of 2 to 3.5 volts is provided this will create a voltage across the LED 206 of 1.5 to 2.5 volts and 0.5 to 2 volts drop across the LED driver circuitry within the optical processor 202 when the LED is active. Similarly, if the voltage V_{LED} between 3.5 and 6 volts is applied to the LED 306, the LDO voltage regulator 304 provides 1.8V supply voltage to the optical processor 302 as shown in FIG. 3. This will provide a voltage of 3-5 volts across the pair of LEDs 306 connected between the V_{LED} voltage node and a 0.5-1 volt drop across the driver circuitry within the optical processor 302. When the LED driver is inactive, the LED driver output will be exposed to the voltage level up to a maximum of V_{LED}. With these differing voltage ranges, it is desirable to be able to protect the circuitry associated with the LED driver in each of the voltage level conditions described with respect to FIGS. 2 and 3.

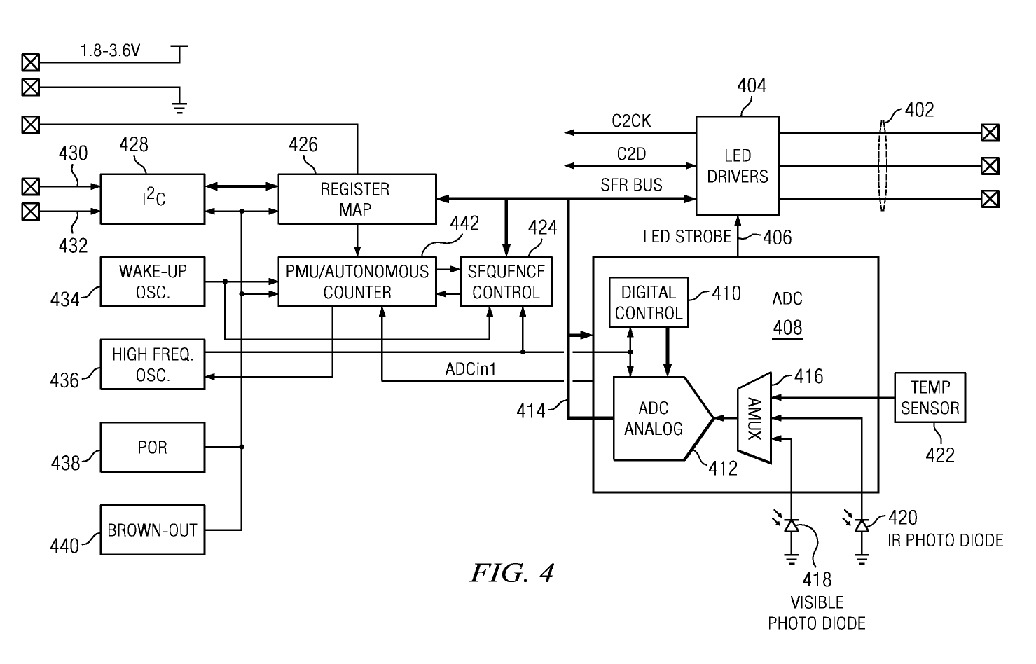

Referring now to FIG. 4, there is illustrated a functional block diagram of an optical sensor which may be used for driving an associated LED responsive to control signals from a host microprocessor over the I2C interface 428. The LEDs are driven responsive to the output at one or more output pins 402. The output pins are connected to the LED driver circuits 404 which provide the output voltages necessary for driving the LEDs connected with the LED pins 402. The specifics of the LED driver circuit 404 will be described more fully herein below. The LED driver circuit 404 receives an LED strobe signal via line 406 from an analog-to-digital circuit 408. The analog-to-digital circuit 408 includes digital control circuitry 410 for providing digital control signals to the analog-to-digital converter 412. The output signals from the analog-to-digital converter 412 are output over a digital SFR bus 414. The analog input is provided to the analog-to-digital converter 412 through an analog multiplexer 416. The analog multiplexer is connected to a visible photo diode 418, an IR photo diode 420 and temperature sensor 422.

The SFR bus 414 interconnects the analog-to-digital converter 412 with a sequence control processing core 424. The SFR bus 414 also connects with a register map 426 for mapping various inputs to associated registers of the LED driver circuitry 404. The external host processor communicates with the optical sensor via an I²C interface 428. The I²C interface 428 receives a clock signal via clock pin 430 and data signals via a data pin 432. Internal clock signals are provided via a wake up oscillator 434 and a high frequency oscillator 436. The power on reset block 438 provides a reset source for the circuit and the brown out circuit 440 provides brown out protection for the circuit. The PMU/autonomous counter 442 provides the counter capabilities necessary for determining when to wake up the central processor 424 from low power states when not running a conversion sequence. The PMU/autonomous counter 442 also controls the LED driver 404, ADC converter and the sensor measurement sequence to provide host controller sensor data over the I2C interface 428. The optical sensor can be configured to measure temperature, ambient light and act as an optical signal receiver from the LEDs controlled by the LED driver 404.

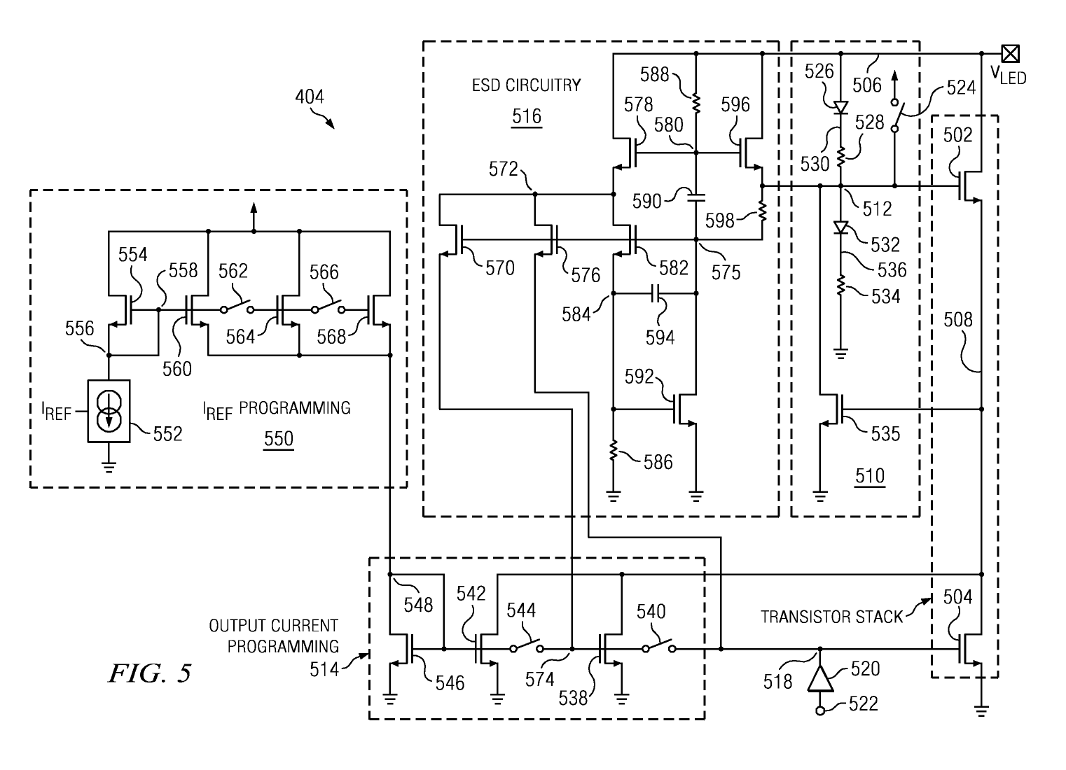

Referring now to FIG. 5, there is illustrated a simplified schematic diagram of the LED driver 404 that is associated with each of the LED drive pins 402 of the sensor described with respect to FIG. 4. The LED driver 404 improves existing techniques for driving a high output LED voltage utilizing an adaptively regulated cascode current source to enable high-voltage operation. The adaptively regulated cascode current source consisting of a stacked pair of transistors including a first N-channel transistor 502 and a second N-channel transistor 504. The transistor 502 has its drain/source path connected between node 506 associated with the V_{LED} output pin and node 508. The transistor 504 has its drain/source path connected between node 508 and ground. The gate of transistor 502 is connected to VSOA biasing circuitry 510 at node 512. The gate of transistor 504 is connected to the current mirror 514 and ESD protection circuitry 516 at node 518. Node 518 is connected with an input driver 520 which provides the input signal to the LED driver circuit 404 through node 522.

As discussed above, the cascode current source of the LED driver consists of a two transistor stack consisting of transistor 502 and transistor 504. Transistor 504 sets an accurate current level while transistor 512 provides voltage protection for transistor 504 and provides the output impedance for the LED driver. Stacking the transistor drivers enables a higher output voltage than a single driver device. The transistors 502 and 504 provide a cascode with high current accuracy and a high output voltage swing. The biasing circuitry 510 protects from high output voltage swings and provides optimum operating conditions of the transistor 504. The bias voltage of transistor 502 is dynamically controlled based upon the mode of operation of the LED driver, either active, inactive or as a GPIO input/output. Transistor 502 must be biased such that a safe voltage operating area is guaranteed for both, transistor 504 and transistor 502. The highest maximum voltage at the output node V_{LED} 506 is provided when the bias voltage applied to the gate of transistor 502 through node 512 (VSOA) is equal to

$$\frac{{V}_{LED}}{2} ,$$

assuming transistors 502 and 504 are of the same type.

The bias voltage VSOA at node 512 that is applied to the gate of transistor 502 is controlled via the biasing circuitry 510. The biasing circuitry 510 consists of a switch 524 that is connected between the supply voltage V_{DD} and node 512. The switch 524 directly biases to node 512 the supply voltage V_{DD}. The bias circuit 510 further includes a series connection of a diode 526 and resistor 528. The diode 526 has its anode connected to node 506 and its cathode connected to node 530. The diode 526 can also be implemented by various devices such as a p-n junction diode, bipolar or MOS transistor as known to one skilled in the art. The resistor 528 is connected between node 530 and node 512. The bias circuitry 510 additionally includes a second series connected diode 532 and resistor 534. The diode 532 has its anode connected to node 512 and its cathode connected to node 536. Resistor 534 is connected between node 536 and ground. The diodes 526 and 532, resistors 528 and 534 form a voltage divider for controlling the bias voltage VSOA. A transistor 535 comprises an N-channels resistor having its drain/source path connected between node 512 and ground. The gate of transistor 535 is connected to node 508. The bias circuitry 510 is dynamically controlled based upon the mode of operation of the driver. The driver may be in an inactive mode, an LED on mode, or a GPIO mode wherein the LED driver is either acting as a general-purpose input or output. The bias voltage applied to node 512 will change based upon the selected mode of operation and the voltage at the output of the LED driver. These various modes of operation will be more fully described herein below. When the bias circuitry 510 is operating in the LED on mode (when the LED driver is actively driving an LED), the bias voltage VSOA is controlled by a regulation feedback such that VSOA does not exceed the headroom of the cascodes controlling the drain voltage of transistor 504 for current accuracy. If the drain to source voltage of transistor 504 is less than ˜0.6 volts, the bias voltage VSOA equals the supply voltage V_{DD}. If the drain to source voltage of transistor 504 is approximately equal to 0.6 volts, the bias voltage VSOA equals 0.6 volts plus the gate to source voltage of transistor 502. The bias voltage VSOA is equal to Vled/2 when the LED driver is in the inactive state thus providing biasing protection for the driver in the inactive state. When driver is in GPIO mode, the switch 524 connects the gate of 502 to the VDD supply voltage.

The output current mirror circuit 514 enables programming of the output current provided from the V_{LED} pin at node 506. The output current mirror circuit 514 is connected with the gate of the lower transistor 504 of the transistor stack at node 518 as discussed previously to mirror an established output current to the LED driver pad. The output current mirror circuit 514 includes an N-channel transistor 538 having its drain/source path connected between node 508 and ground. A switch 540 is used for switching the current into the current mirror comprising the output current mirror circuit 514 in order to control the level of the current provided to the output node 506. A transistor 538 comprises an N-channel transistor having its drain/source path connected between node 508 and ground. A switch 544 is used for switching the transistor 538 into the current mirror for adjusting the output current using the output current programming circuit 514. A transistor 546 comprises an N-channel transistor having its drain/source path connected between node 548 and ground. The gate of transistor 546 is connected to its drain and to the gate of transistor 542, forming a canonical version of the output current mirror for the LED drive output. The gates of each of transistors 546, 542 and 538 are connected such that the transistors form a scalable current mirror. By switching transistors 542 and 538 in parallel with transistor 546, the current that is being provided at node 508 via the current mirror can be adjusted, and thus, the output current provided at node 506 and the V_{LED} pin may be adjusted. The current level at the output of the LED driver is controlled by adjusting the ratio of the output current mirror circuit 514 by switching transistors 542 and 538 into the circuit via switches 544 and 540, respectively. While the present simplified description has been illustrated with respect to two additional transistors that may be switched into the current mirror, any number of associated transistors may be utilized within the output current mirror circuit 514 in order to more fully control the output current provided at node 508.

The reference current I_{REF} which is input to the output current mirror circuit 514 to be mirrored from transistor 546 via the output current mirror circuit 514 is provided by a programmable reference current circuit 550 at node 548. The programmable reference current circuit 550 also comprises a current mirror circuit for providing a programmable reference current I_{REF} responsive to the provided current source I_{REF} 552. A P-channel transistor 554 has its drain/source path connected between the supply voltage node V_{DD} and node 556 connected to the output of the I_{REF} current source 552. The gate of transistor 554 is connected to its source at node 556. The gate is at node 558 that is connected with the gates of each of the other N-channel transistors forming the reference current programming circuit 550 current mirror.

Transistor 560 has its gate connected to node 558 and its drain/source path connected between the V_{DD} supply node and node 548. A transistor 564 has its drain/source path connected between the V_{DD} supply node and node 548. A switch 562 is used for connecting transistor 564 in parallel with node 560 in order to adjust the programmable reference current I_{REF} provided at node 548. A transistor 568 has its drain/source path connected between the V_{DD} supply node and node 548. A switch 566 is used for switching transistor 568 into parallel with transistor 560 to adjust the current being mirrored to node 548. The illustration of FIG. 5 shows two transistors 564 and 568 which may be switched in parallel with transistor 560 in order to alter the programmable current I_{REF} which is mirrored to node 548. It should be realized, that any number of transistors may be placed in parallel with transistor 560 in order to provide a higher level of control to the reference current being provided at node 548.

The ESD protection circuitry 516 protects the circuitry within the LED driver 402 from high-voltage transients applied at node 506 through the driver pad V_{LED}. The ESD protection circuitry 516 protects the circuitry of the LED driver 402 from electrostatic discharges through the node 506 provided at the V_{LED} pad. Transistor 570 has its drain/source path connected between node 572 and node 574. The gate of transistor 570 is connected to node 574. A transistor 576 has its drain/source path connected between node 572 and node 518. The gate of transistor 576 is connected to node 575. Transistor 578 has its drain/source path connected between node 506 and node 572. The gate of transistor 578 is connected to node 580. Transistor 582 has its drain/source path connected between node 572 and node 584. A resistor 586 is connected between node 584 and ground. A resistor 588 is connected between node 506 and node 580. A capacitor 590 is connected between node 580 and node 575. A transistor 592 has its drain/source path connected between node 575 and ground. The gate of transistor 592 is connected to node 584. A capacitor 594 is connected between node 584 and node 575. Transistor 596 has its gate connected to node 580 and its drain/source path connected between node 506 and node 512. A resistor 598 is connected between node 512 and node 575.

The circuit of FIG. 5 illustrates a single LED driver 402. The LED driver circuit 402 may include multiple drivers within a single block such as LED driver blocks such as that described with respect to FIG. 4. Thus, the above circuitry would be repeated for each of the LED outputs which were being provided at a V_{LED} pin.

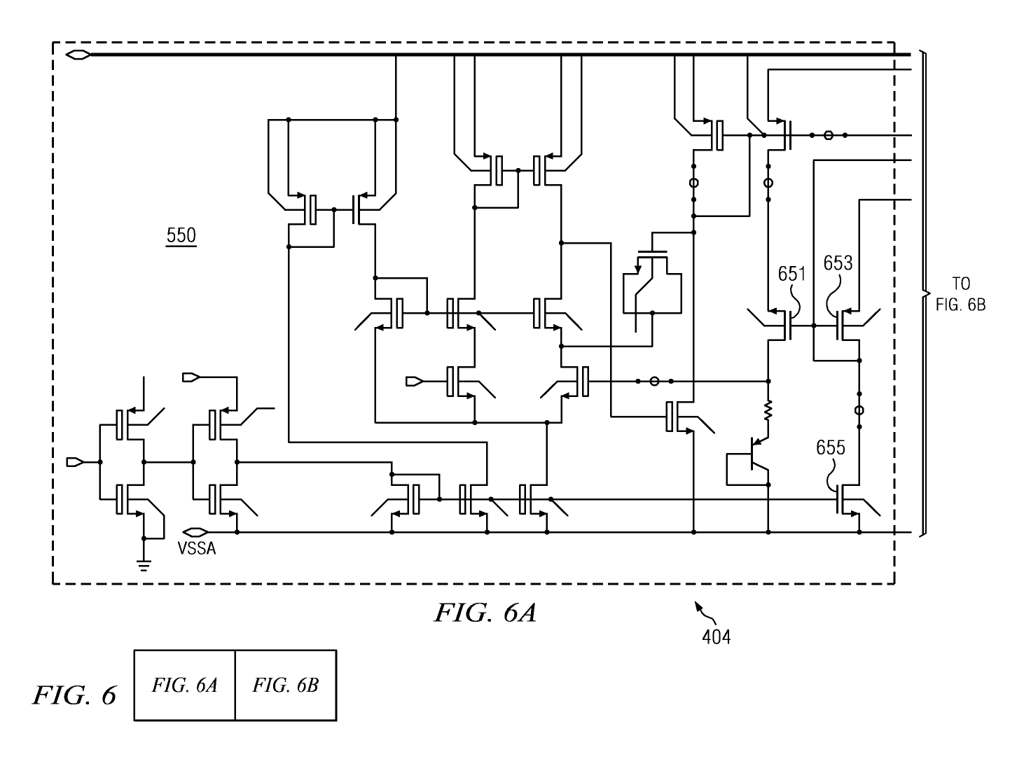

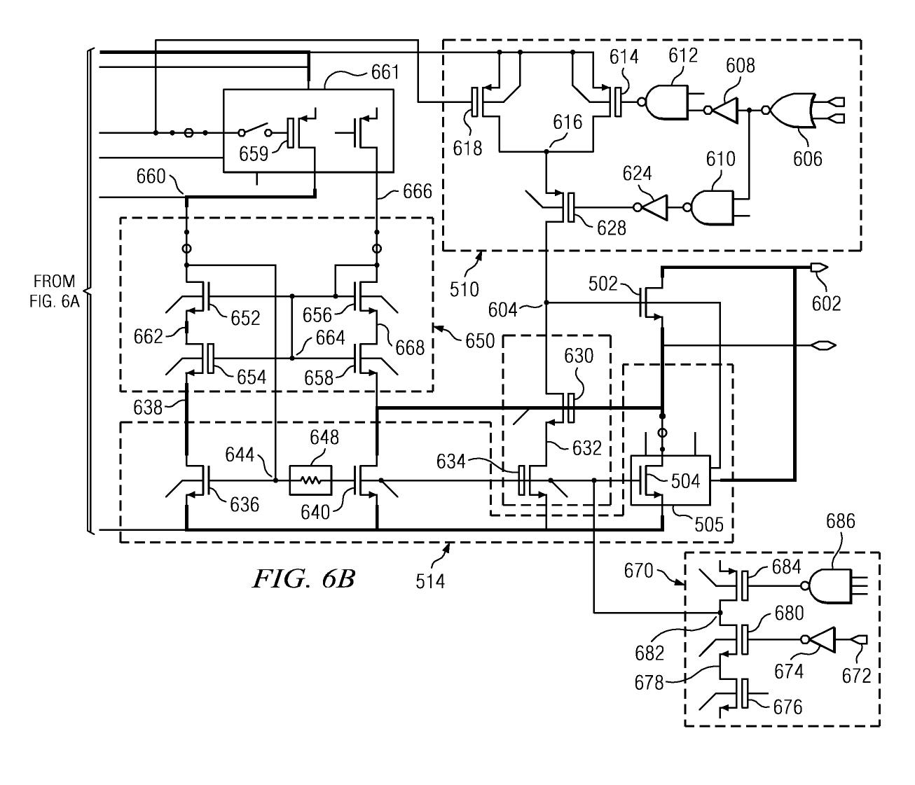

Referring now to FIG. 6, there is provided a more detailed schematic diagram of the LED driver circuitry 402. The stacked transistors providing the output drive signal to output node 602 consists of transistor 502 and transistor 504. The bias voltage circuitry 510 is connected to the gate of transistor 502 at node 604. The bias voltage circuitry 510 receives a signal DIG_EN (digital enable) and ANA_EN (analog enable) at the input of a NOR gate 606. The output of NOR gate 606 is provided to the input of an inverter 608 and an input of NAND gate 610. The other input of NAND gate 610 is connected to receive the LEDONB signal. The output of the inverter 608 is connected to one input of a NAND gate 612. The other input of NAND gate 612 is connected to receive the signal LEDONB. The output of NAND gate 612 is provided to the gate of a P-channel transistor 614. The source/drain path of the transistor 614 is connected between the supply voltage V_{DD} and node 616. A P-channel transistor 618 is connected in parallel with transistor 614 and has its source/drain path connected between the supply voltage node V_{DD} and node 616. The gate of transistor 618 is connected to node 620.

The output of NAND gate 610 is connected to the input of an inverter consisting 624. The output of the inverter 624 is connected to the gate of a P-channel transistor 628. Transistor 628 comprises a P-channel transistor having its source/drain path connected between node 616 and node 604. The gate of transistor 628 is connected to node 624. Transistor 630 has its drain/source path connected between node 604 and node 632. Transistor 634 is an N-channel transistor having its drain/source path connected between node 632 and ground.

The output current mirror circuit 514 includes a current mirror consisting of transistor 636 having its drain/source path connected between node 638 and ground and a transistor 640 having its drain/source path connected between node 642 and ground. The gate of transistor 636 is connected to node 644. A gate of transistor 640 is connected to node 646. A resistor 648 is connected between node 644 and node 646. The resistor 648 is an auxiliary component which is not necessary for operation and may be removed.

A current stabilization circuit 650 regulates the drain to source voltage of transistor 636 to be the same as the drain to source voltage of each of the transistors 640, 634, etc. in the output current mirror circuit 514. This ensures that the output current provided at pad 602 will be stable with varying output LED voltage. The current stabilization circuit 650 includes a current mirror consisting of transistors 652, 654, 656 and 658. Transistor 652 has its drain/source path connected between node 660 and 662. Transistor 645 comprises an N-channel transistor having its drain/source path connected between node 662 and node 638. The gate of transistor 652 is connected with the gate of transistor 656 at node 664. The gate of transistor 654 is also connected to the gate of transistor 658 at node 664. Transistor 656 is an N-channel transistor having its drain/source path connected between node 666 and node 668. Transistor 658 is an N-channel transistor having its drain/source path connected between node 668 and node 642. N-channel transistor 667 has its drain/source path connected between node 666 and ground. The gate of transistor 667 is connected to receive the LEDONB signal.

Connected with the circuitry at node 620 and 660 is the programmable reference current circuit 550 as discussed previously with respect to FIG. 5. The programmable reference current circuit is used for generating the reference current that is applied to the current mirror through node 638. Transistors 651, 653 and 655 perform a similar function to the current stabilization circuit 650 described herein above. These components regulate the drain to source voltage of transistor 657 to match the drain to source voltage of the “D1” transistors 659 in the MP block 661. To stabilize the scaled reference current with respect to the supply voltage V_{DD}.

The GPIO control input to the LED driver is provided through an input stage 670. A digital input is applied at an input node 672. This passes through an inverter 674 whose output is connected to the gate of transistor 676. The drain/source path of the N-channel transistor 676 is connected between node 678 and ground. Transistor 680 is an N-channel transistor having its drain/source path connected between node 682 and node 678. The gate of transistor 680 is connected to receive the LEDONB signal. A P-channel transistor 684 has its source/drain path connected between the supply voltage V_{DD} and node 682. The gate of transistor 684 is connected to the output of a NAND gate 686. The inputs of the NAND gate 686 are connected to receive the DIG_RX, DIG_TX and LEDONB signals.

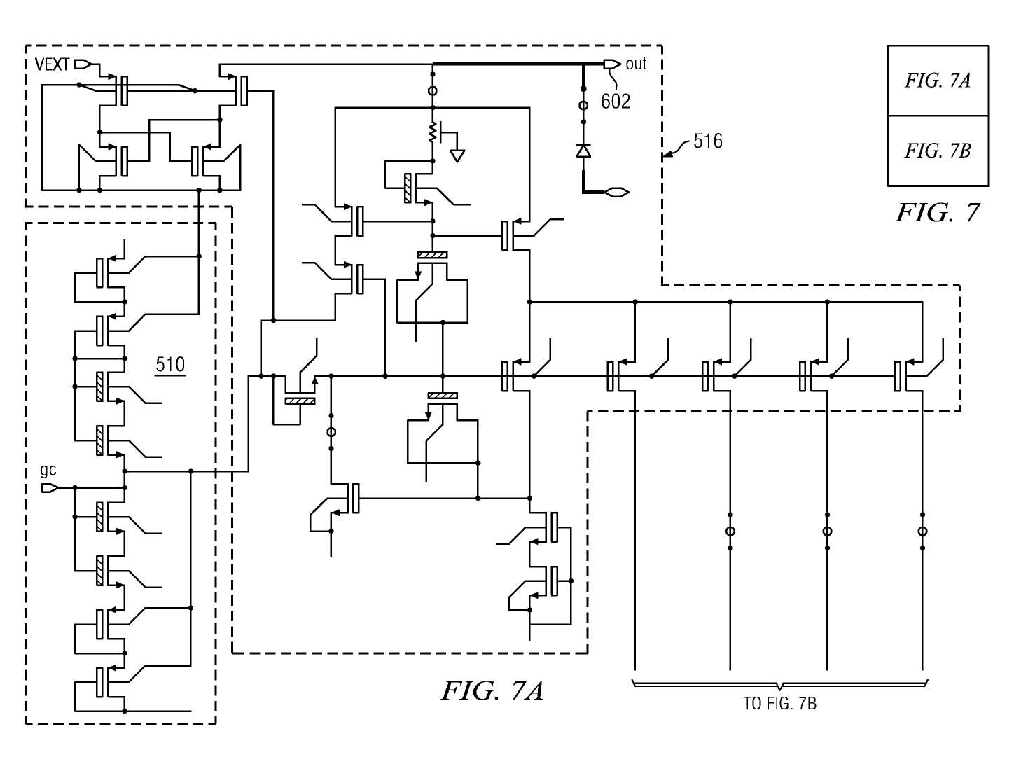

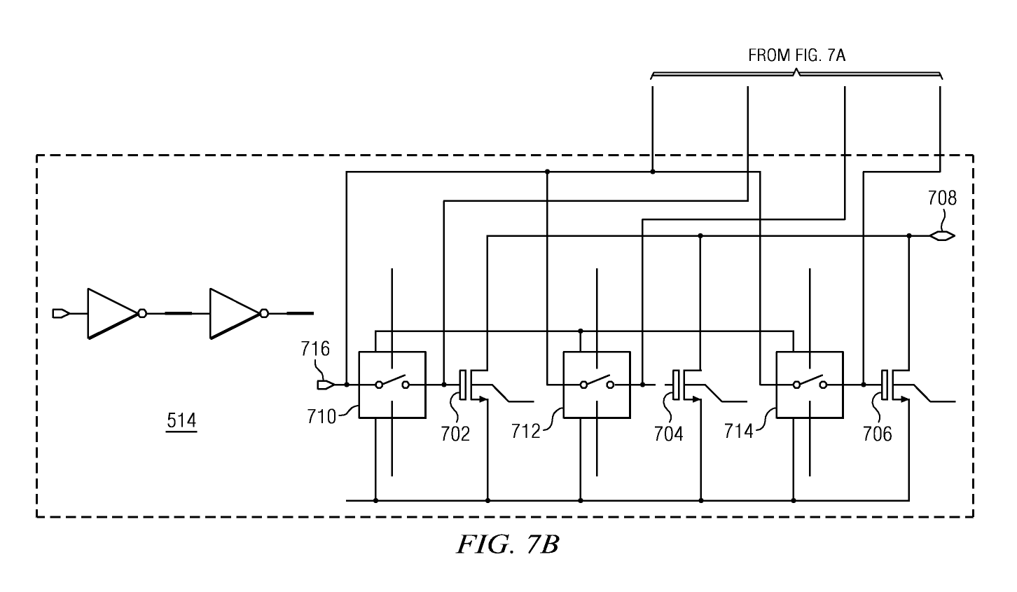

Referring now to FIG. 7, there is more fully illustrated the ESD circuitry 516, the output current mirror circuit 514 and the bias circuitry 510. This would be located within block 505 in FIG. 6. As described previously, the bias circuitry 510 provides the bias voltage to the gate of transistor 502. The ESD protection circuitry 516 protects the circuitry of the LED driver from electrostatic discharge at the input pin 602. The output current mirror circuit 514 provides the manner for controlling the output current by adding one or more of transistors 702, 704 or 706 in parallel with the mirrored current through transistor 636. Transistor 702 has its drain/source path connected between node 708 and ground. Transistor 702 is connected to increase the output current by 2× by closing switch 710. Transistor 704 has its drain/source path connected between node 708 and ground. Transistor 704 may be connected to increase the output current by 4× by closing switch 712. Transistor 706 has its drain/source path connected between node 708 and ground and may be used to increase the output current by 8× responsive to closing switch 714. Switch 710 is connected between the gate of transistor 702 and node 716. The switch 712 is connected between the gate of transistor 704 and node 716 and switch 714 is connected between the gate of transistor 706 and node 716.

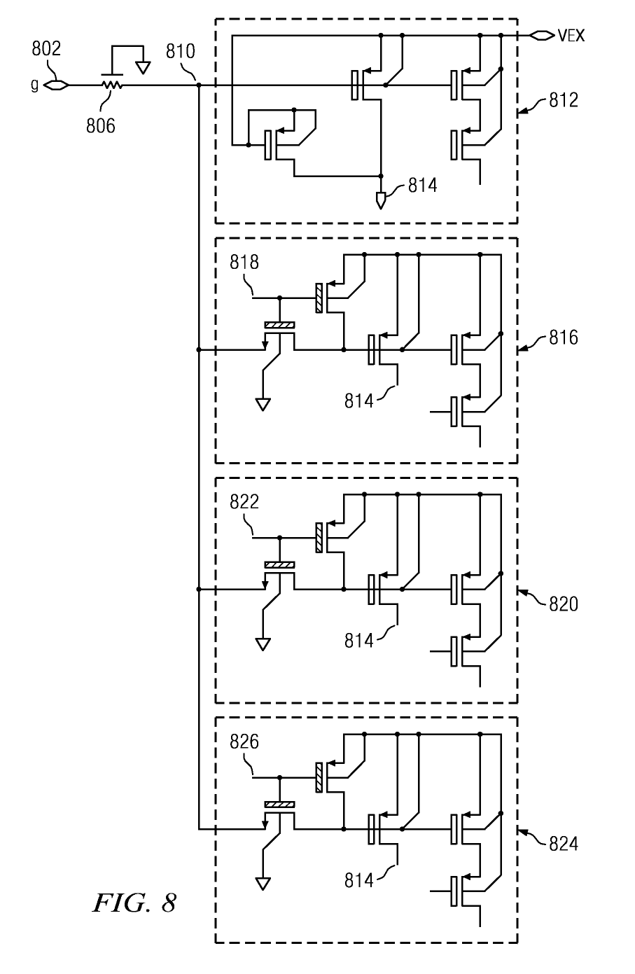

Referring now to FIG. 8, there is more fully illustrated the reference current programming circuit 550. This circuitry is within block 661 of FIG. 6. The reference current is applied at node 802 from the reference current source. The reference current goes through a resistor 806 to node 810. The circuit 812 provides the output current at node 814 at the reference current programmed value. Circuit 816 may be turned on responsive to an input at node 818 to multiply the currents to 8 times the reference current value at node 814. Circuit 820 may be turned on responsive to an input at node 822 to provide the reference current multiplied 16 times at node 814. Finally, circuit 824 may be turned on responsive to an input at node 826 to provide 32 times the reference current at node 814. Thus, by actuating the appropriate circuit, the reference current applied to the programmable current mirror may be controlled as desired responsive to control inputs to node 818.

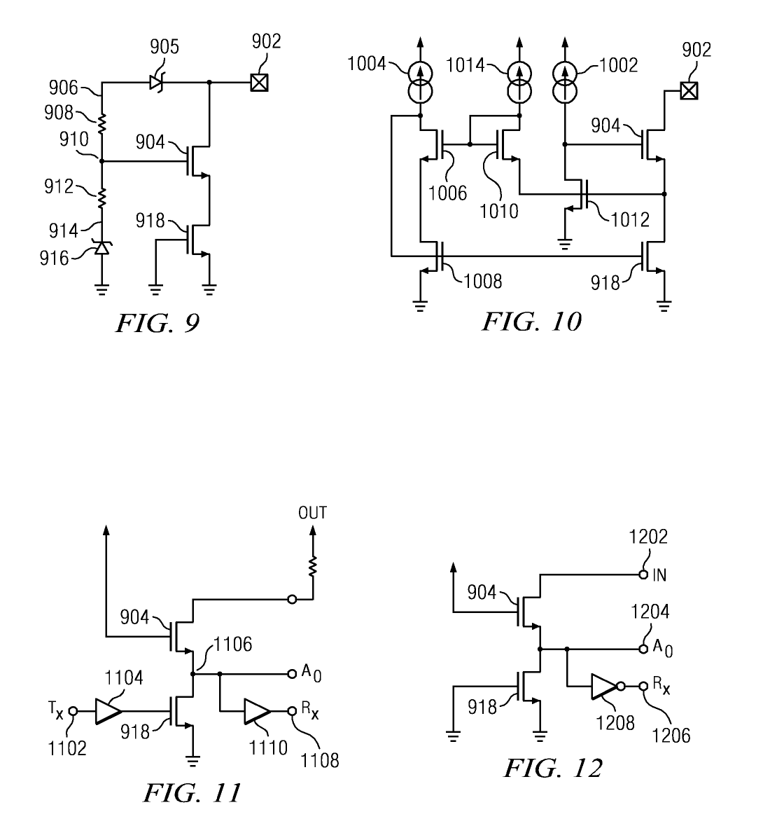

Referring now to FIGS. 9-12, the LED driver may operate in several different modes of operation. In the LED off mode (FIG. 9), the driver is inactive and has the bias voltage applied to node 910 (VSOA) to protect the cascode current source. In the LED on mode (FIG. 10), the LED driver circuitry is active for driving the LED through the output pad and the bias circuitry is active to establish a bias voltage to allow the widest possible bias swing and the reference current and output current are programmed to desired levels. In the GPIO output mode (FIG. 11), the LED driver may output a digital or analog signal to the driver output “OUT”. Similarly, in the GPIO input mode (FIG. 12), the driver may receive a digital or analog signal via the driver signal “IN”.

Referring now more particularly to FIG. 9, there is more fully illustrated a simplified schematic diagram of the LED driver in the inactive (LED off) mode of operation. The bias voltage VSOA applied at the gate of transistor 904 is provided via the voltage divider circuit consisting of a zener diode having its cathode connected to node 902 and its anode connected to node 906. In the inactive mode of operation, the gate of transistor 904 is connected to one-half the LED voltage via the voltage divider circuit. A resistor 908 connected between node 906 and node 910 connected to the gate of transistor 904. Transistor 912 connected between node 910 and node 914. Zener diode 916 has its cathode connected to node 914 and its anode connected to ground. The bottom transistor 918 of the transistor stack is connected between transistor 904 and ground and has its gate connected to ground.

Referring now to FIG. 10, there is illustrated the configuration of the LED driver when in the active mode of operation for driving an LED. In this case, the bias voltage is provided at the gate of transistor 904 responsive to the bias voltage source 1002 described herein above. In the LED active mode, the gate of transistor 904 is regulated to provide the VSOA voltage necessary to provide a safe operating voltage range for transistors 904 and 918. The reference current I_{REF} is provided from source 1004 using the programmable current source circuitry described herein above. This current is provided through transistors 1006 and 1008 and is mirrored through transistor 918 to act as the output current through pad 902. The output current can be programmed in the manner described previously. Transistors 1010 along with source 1014 comprise the drain regulation of the 1008 for output LED current accuracy of the 918.

In addition to the active and inactive modes of operation, the LED driver may operate as a GPIO output as illustrated in FIG. 11. In the GPIO input/output mode of operation, the gate of transistor 904 is connected to V_{DD} and the gate of transistor 918 is connected to receive the digital control signal. In the GPIO output mode, a digital control signal is provided at node 1102 and is driven by a driver 1104 to the gate of transistor 918. The output of the LED driver circuit out is connected to an external voltage source via a pull-up resistor to define a logic high level. The internal node 1106 may comprise a digital output at node 1108 after passing through a driver 1110.

Finally, the LED driver may be configured as a general purpose input wherein the input signal is applied to the drain of transistor 904 at node 1202 as shown in FIG. 12. In the GPIO input/output mode of operation, the gate of transistor 904 is connected to V_{DD} and the gate of transistor 918 is connected to receive the digital input signal. The input signal at node 1202 may then be output via node 1204 as an analog signal or output as a digital signal at node 1206 through a level shifter 1208. In the GPIO output configuration, the gate of transistor 904 is connected to the supply voltage V_{DD} and the gate of transistor 918 is connected to ground.

It will be appreciated by those skilled in the art having the benefit of this disclosure that this high-voltage constant-current LED driver for optical processor provides numerous functions not present in existing LED drivers. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. An LED driver, comprising:
a first transistor for setting an output current level at an output of the LED driver responsive to a programmable current and an input signal;
a second transistor in series with the first transistor for providing voltage protection for the first transistor;
wherein the first transistor and the second transistor support an output voltage higher than a maximum operating voltage of either the first or the second transistor alone; and
biasing circuitry for generating an adaptive bias voltage for the second transistor to protect the first transistor and the second transistor from high voltage levels at the output of the LED driver.

2. The LED driver of claim 1, further including:
a reference current source for generating a reference current; and
a programmable output current circuit for generating the programmable current responsive to the reference current.

3. The LED driver of claim 2, wherein the biasing circuitry further generates the adaptive bias voltage responsive to the operating mode of the LED driver and a voltage at the output of the LED driver.

4. The LED driver of claim 1, wherein the programmable output current circuit comprises a programmable current mirror providing the programmable current to a gate of the first transistor responsive to the reference current, the programmable current mirror including a plurality of transistors that are selectively connected to the programmable current mirror to selectively control the programmable current.

5. The LED driver of claim 1, further including a current stabilization circuit for stabilizing the output current level at the output of the LED driver in response to a varying voltage at the output of the LED driver.

6. The LED driver of claim 1 further including a programmable reference current circuit for generating a programmable reference current responsive to the reference current from the reference current source.

7. The LED driver of claim 1 further including ESD protection circuitry associated with the output of the LED driver for protecting the LED driver from high-voltage transients at the output of the LED driver.

8. The LED driver of claim 7, wherein the first transistor and the second transistor operate with the ESD protection circuitry to protect the LED driver from high-voltage transients at the output of the LED driver.

9. An LED driver, comprising:
a first transistor for setting an output current level at an output of the LED driver responsive to a programmable current and an input signal;
a second transistor in series with the first transistor for providing voltage protection for the first transistor;
wherein the first transistor and the second transistor support an output voltage higher than a maximum operating voltage of either the first or the second transistor alone;
biasing circuitry for generating an adaptive bias voltage for the second transistor to protect the first transistor and the second transistor from high voltage levels at the output of the LED driver;
a reference current source for generating a reference current; and
a programmable current mirror for generating a programmable current to a gate of the first transistor responsive to the reference current, the programmable current mirror including a plurality of transistors that are selectively connected to the programmable current mirror to selectively control the programmable current.

10. The LED driver of claim 9, wherein the biasing circuitry further generates the adaptive bias voltage responsive to the operating mode of the LED driver and a voltage at the output of the LED driver.

11. The LED driver of claim 9, further including a current stabilization circuit for stabilizing the output current level at the output of the LED driver in response to a varying voltage at the output of the LED driver.

12. The LED driver of claim 9 further including a programmable reference current circuit for generating a programmable reference current responsive to the reference current from the reference current source.

13. The LED driver of claim 9 further including ESD protection circuitry associated with the output of the LED driver for protecting the LED driver from high-voltage transients at the output of the LED driver.

14. The LED driver of claim 13, wherein the first transistor and the second transistor operate with the ESD protection circuitry to protect the LED driver from high-voltage transients at the output of the LED driver.

15. An LED driver, comprising:
a first transistor for setting an output current level at an output of the LED driver responsive to a programmable current and an input signal;
a second transistor in series with the first transistor for providing voltage protection for the first transistor;
wherein the first transistor and the second transistor support an output voltage higher than a maximum operating voltage of either the first or the second transistor alone;
biasing circuitry for generating an adaptive bias voltage for the second transistor to protect the first transistor and the second transistor from high voltage levels at the output of the LED driver;
a reference current source for generating a reference current;
a programmable reference current circuit for generating a programmable reference current responsive to the reference current from the reference current source;
a programmable current mirror for generating a programmable current to a gate of the first transistor responsive to the reference current, the programmable current mirror including a plurality of transistors that are selectively connected to the programmable current mirror to selectively control the programmable current;
a current stabilization circuit for stabilizing the output current level at the output of the LED driver in response to a varying voltage at the output of the LED driver; and
ESD protection circuitry associated with the output of the LED driver for protecting the LED driver from high-voltage transients at the output of the LED driver.

16. The LED driver of claim 15, wherein the biasing circuitry further generates the adaptive bias voltage responsive to the operating mode of the LED driver and a voltage at the output of the LED driver.

17. The LED driver of claim 15, wherein the first transistor and the second transistor operate with the ESD protection circuitry to protect the LED driver from high-voltage transients at the output of the LED driver.
